(19) United States
(12) Patent Application Publication
(10) Pub. No.: US 2002/0119084 A1
(43) Pub. Date: Aug. 29, 2002

(54) Reactor for a fuel cell system and method of making a reactor

(76) Inventors: Stefan Boneberg, Beuren (DE); Thomas Stark, Kirchheim/Teck (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/061,451

(22) Filed: Feb. 4, 2002

(30) Foreign Application Priority Data
Feb. 2, 2001 (DE) 101 04 601.4-41

(51) Int. Cl. B01J 8/04; B01J 8/02; F28D 9/00; F28D 1/03

(52) U.S. Cl. 422/199; 422/198; 422/188; 422/190; 422/191

(57) ABSTRACT

A reactor has a catalytically coated metallic catalyst carrier. The catalyst carrier is constructed as part of an electric circuit and is acted upon by a medium to be catalytically converted. The catalyst carrier is arranged at least in areas in the flow path of a medium to be converted by the catalyst, and this medium can flow through the catalyst carrier.

### BACKGROUND AND SUMMARY OF THE INVENTION

This application claims the priority of German Patent Document No. 101 04 601.4-41, filed Feb. 2, 2001, the disclosure of which is expressly incorporated by reference herein.

The invention relates to a reactor for a fuel cell system and method of making a reactor.

During the starting phase of a vehicle supplied or driven with energy from a fuel cell system, emissions are generated which are not converted and therefore reach the exhaust gas. In reformer systems in which hydrogen for operating the fuel cell module must first be obtained from a combustion medium, a relatively high temperature is required so that the catalysts for the reforming and the removal of carbon monoxide from the reformate can operate with sufficient efficiency. Emissions will occur as long as the fuel cell system is not yet at its operating temperature, for example, to ensure a complete removal of the carbon monoxide from the reformate. In the starting phase, the efficiency of the fuel cell system is therefore also low. In order to bring the constituents as rapidly as possible to the operating temperatures, cold-start components are suggested which generate heat, and the like, for example, by means of an additional combustion.

German Patent Document DE 196 40 577 A1 discloses the use of a directly energized metal carrier as a catalyst which is electrically heated in the starting phase, so that the catalyst arrives at the operating temperature more rapidly. In this case, electric current flows through a catalytically coated metal sheet which is heated by ohmic losses.

German Patent Document DE 197 53 206 C1 discloses an electrically heatable catalyst in which a fiber mat is wound up in the manner of a filter candle, and electric heating wires are arranged outside the fiber material on which a catalytic conversion of a medium takes place. The heating device is preferably mounted on the outer circumference of the wound-up fiber mat. The medium flows essentially in the axial direction of the winding through the arrangement. The heating wires heat the catalyst in a homogeneous manner and provide a uniform conversion of the medium in the arrangement. The heating device has the effect that, during a continuous operation of the catalyst, the temperature remains as constant as possible and the catalyst is homogeneously heated, so that the medium is always optimally converted there.

It is an object of the invention to provide a reactor which has a cold-starting phase which is as brief as possible and which reactor is particularly suitable for a fuel cell system.

This object is achieved by a reactor described below.

The advantage of the solution according to the invention is that the reactor can be rapidly heated and it prevents in a reliable manner that locally overheated sites are formed which impair the operation of the reactor or its service life.

It is understood that the above-mentioned characteristics and the characteristics which will be explained in the following can be used not only in the respectively indicated combination but also in other combinations or alone without leaving the scope of the present invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a lateral view of a preferred reactor having a catalyst carrier and an insulating material of the type of a filter candle.

FIG. 2 is a top view of a preferred reactor of the type of a filter candle.

FIG. 3 is a top view of a preferred embodiment of the reactor.

FIG. 4 is a top view of a favorable further development of a preferred reactor.

### DETAILED DESCRIPTION OF THE DRAWINGS

The invention is particularly suitable for reactors in fuel cell systems which are operated in mobile systems, particularly in vehicles. The reactor of the present invention may have a very compact construction.

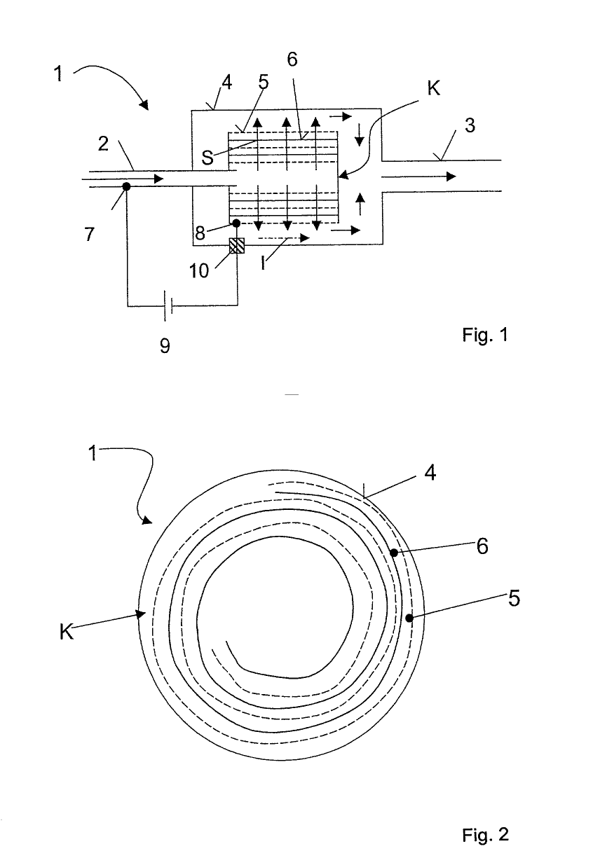

FIG. 1 illustrates a preferred reactor 1. The reactor has a housing 4 with a medium supply device 2 and a medium removal device 3. The medium flow is indicated by arrows. In the interior of the reactor 1, a catalyst unit K is arranged which has an electrically conductive, essentially flat catalyst carrier 5 which is indicated by a broken line. In this example, the catalyst unit K is constructed in the manner of a filter candle; that is, the catalyst carrier 5 is wound in several layers around the medium supply device 2 constructed as a pipe. In this case, the individual layers of the catalyst carrier 5 are separated from one another by an electric insulating material 6. In this case, the catalyst carrier 5, as well as the insulating material 6, are porous, and the medium flows essentially perpendicularly through the flat catalyst carrier 5 and the insulating material 6. The preferred embodiment of the catalyst unit K is a cylindrical filter candle with several layers of metallic catalyst carrier and layers of insulating material arranged in-between, the main flow direction S in the preferred embodiment is therefore essentially radial.

The medium flowing into the reactor 1 flows axially, for example, into the center of the filter candle, and flows radially through the catalyst carrier 5 and the insulating material 6. The medium is converted there and is collected in the area between the housing 4 and the outer boundary of the filter candle. The medium then is discharged from the reactor 1 by way of the medium removal device 3. The catalyst carrier 5 is situated at least in areas perpendicular in the flow path of the medium. The main flow path of the medium is perpendicular through the catalyst carrier 5, and the catalytic conversion of the medium also mainly takes place there. In this case, the conversion also takes place essentially within the catalyst carrier in its pores and/or on its surface. The medium does not flow past its flat surface but penetrates the body of the catalyst carrier 6.

Then, preferably medium can flow through the catalyst unit K preferably virtually only radially. In the axial direction, the catalyst unit K is essentially closed off with respect to the housing.

A first electric contact 7 is arranged at a first contact point of the reactor 1 and a second electric contact 8 is arranged at a second contact point of the reactor 1 such that the electric current flow I takes place essentially perpendicular to the flow direction S of the medium through the catalyst carrier S.

As a result, the catalyst carrier 5 is heated directly and is very rapidly brought to its reaction temperature or another desired temperature. Because the catalytically active material is preferably directly on the metallic catalyst carrier 5, possibly by means of a bonding layer, the thermal coupling is good.

Preferably, the first contact 7 is arranged on the medium supply device and the second contact 8 is arranged on the outer boundary of the filter candle or of the catalyst carrier 5, so that, on the whole, an electric current I flows through the entire electrically conductive catalyst carrier 5 in its longitudinal dimension. The catalyst carrier 5 is used as a heating resistance.

It is advantageous that the electrically conductive catalyst carrier can be heated by an electric current, so that a higher operating temperature can be reached very rapidly. The electric insulation, through which the medium can flow, ensures that the electric current flows along the entire longitudinal dimension of the catalyst carrier and heats the latter in a uniform manner.

The catalyst carrier 5 and the insulating material 6 are preferably constructed as bands or mats. As a result, a filter candle can be wound in a particularly simple fashion. The catalyst carrier 5 and the insulating material 6 preferably have the same width, the width corresponding essentially to the axial length of the filter candle.

FIG. 2 is a cross-sectional view of a preferred reactor 1 of this type in the form of a filter candle shown in FIG. 1. If the catalyst unit K of the reactor is constructed like a preferred filter candle, in the simplest case, a layer of electric insulation material 6 may be placed on a layer of an electrically conductive catalyst carrier 5 of approximately the same size, and the two layer can then be wound up. In this case, several layers of the insulating material 6 may also be arranged between two layers of the catalyst carrier 5.

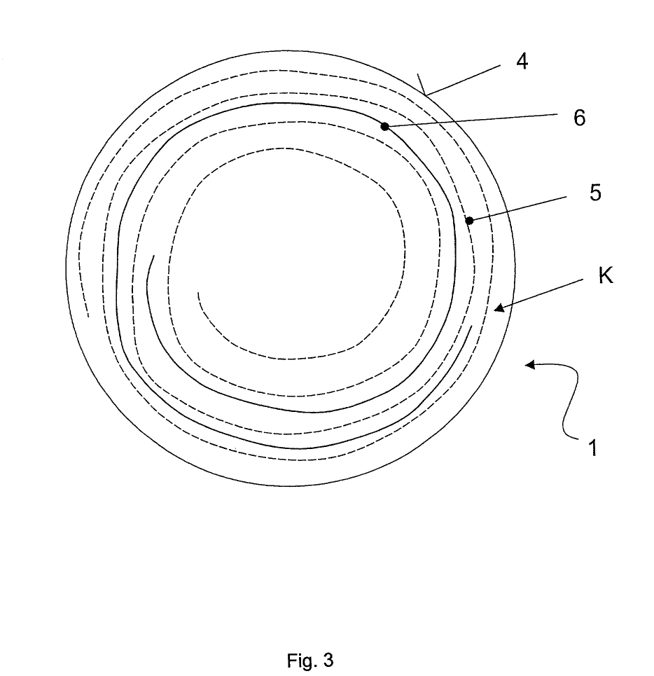

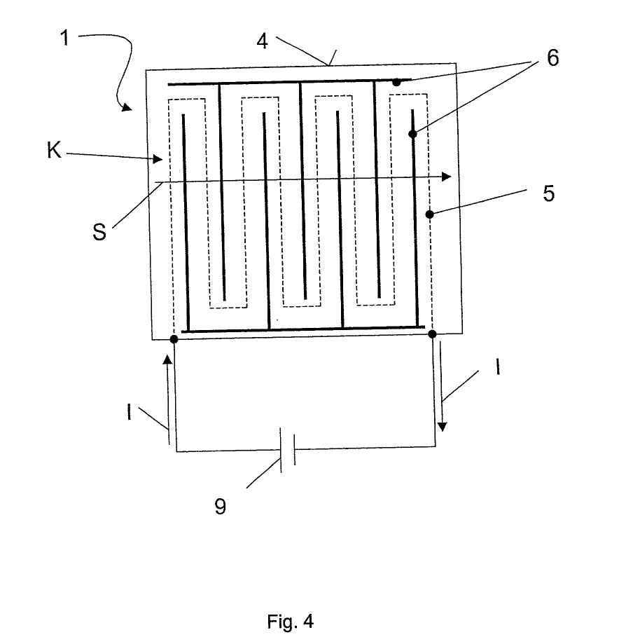

FIG. 3 illustrates a preferred further development of the invention. The catalyst unit is again constructed in the manner of a filter candle. However, the electrically insulating layer 6 is arranged only on selected areas of the catalyst unit, i.e., in the center of the filter candle arrangement with the electric insulation 6 extending over several windings in the circumferential direction. As a result, the electric resistance of the catalyst unit K is low at the beginning and at the end of the catalyst carrier 5 and is high in the center. Correspondingly, the ohmic losses and thus the temperature are high in the center. As a result, a temperature distribution which is adapted to the occurring reaction can advantageously be defined in the reactor. This permits a homogeneous reaction in the volume of the reactor.

If, for example, an exothermal conversion of the medium takes place, such as a catalytic oxidation of residual hydrogen in the fuel cell exhaust gas, an undesirably high temperature peak can be avoided in the inlet area and/or in the outlet area of the reactors. In addition, energy is supplied in the central area as a result of heating. Further, a lowering of the conversion of the fuel cell waste gas is avoided or at least reduced, which is caused by the continuous decrease of the residual hydrogen in the waste gas when passing through the reactor.

As a result, an excessive temperature in the inlet area of the catalyst carrier 5 can be prevented, thereby avoiding damaging the catalyst carrier 5 or impairing the catalytic conversion of the medium.

By means of such an arrangement, the temperature distribution can be adjusted in a targeted manner within the catalyst arrangement.

If the dissipation of heat from the interior of the filter candle is low, the catalyst carrier can be designed to be of relatively low impedance there, because it is sufficiently heated there by the feeding of energy from the environment.

Naturally, the arrangement of the electric insulation 6 may also be provided at a different point of the preferred filter candle or may have several electric insulations 6 interrupted in the circumferential direction. As a result, the temperature distribution can be correspondingly optimized for the respective use of the reactor.

A favorable possibility of such a further development includes covering a strip-shaped catalyst carrier 5 at least in some areas by means of one or several strips of electric insulating material 6 and by means of a winding-up in the manner of a filter candle.

It is particularly advantageous to vary the electric resistance of the catalyst carrier 5 along the flow direction S of the medium, in that the electrically conductive catalyst carrier 5 has varying electric characteristics along its longitudinal dimension. For example, the catalyst carrier may have a thicker construction, which reduces the electric resistance, and the like.

The catalyst carrier 5 is advantageously formed of a metallic woven fabric or of a metallic network or of a perforated sheet or of a sponge-type metallic material.

A particularly favorable material for the insulating layers 6 is a so-called ceramic paper which has the necessary flexibility for being used, for example, in a filter candle. Additionally, the electric insulating property is very good in the installed condition between catalyst carrier layers 6. It is advantageous to provide the electric insulation also with a catalyst material so that the catalytic activity of the arrangement is increased. As a result of the adaptation of the electric resistance of the catalyst carrier 5, of the insulating layer arrangement and/or of the chemical activity, one reactor respectively can be adapted to different uses.

When the catalyst carrier 5 has sufficient mechanical stability so that the individual winding layers do not contact one another, the layers of the catalyst carrier 5 may be electrically insulated by their geometrical spacing, for example, preferably by air.

FIG. 4 illustrates a further development of a preferred reactor 1. The catalyst carrier 5 is arranged in the manner of a plate arrangement or of a meandering arrangement. The individual plates of the catalyst carrier are separated by plates of an electric insulator 6. The medium to be converted flows inside the housing through the plates of the catalyst carrier 5. An electric current I flows through the catalyst carrier 5 for the purpose of heating. If the catalyst carrier 5 is not constructed to be continuous but as separate individual plates, electric contact can be established, for example, by way of conductive bridges between the plates, or the plates can be energized in parallel.

The catalyst unit K may also be made from an electrically conductive monolith which is energized in a suitable manner. Also in this case, it is possible to adjust, by the successive arrangement of catalyst material areas with different electrical properties, the ohmic losses along the flow direction of the medium through the catalyst or the running length of the reactor 1 in a locally differentiated manner, so that a temperature distribution in the reactor can be set in a targeted fashion.

A reactor 1 according to the invention permits the electrically charging of activating energy directly into the catalyst, for the start of a chemical conversion of a medium on the catalyst, such as a fuel or a pollution gas. The heat fed into the catalyst permits an immediate lighting-off and converting of the medium, allowing an optimization of the conversion of the medium. This is particularly advantageous when a conversion of the medium, as complete as possible, in the reactor is desired. This is frequently the case during reactions in fuel cell systems, for example, when generating hydrogen in a gas generating system or when treating fuel cell waste gas.

The reactor 1 is preferably arranged in a fuel cell system, in which case the medium to be converted is, for example, a mixture of air, hydrogen, methanol and/or other alcohols and/or other ethers and/or carbon monoxide. By means of the reactor according to the invention, particularly undesirable emissions can be avoided or at least reduced specifically in the starting phase under cold-starting conditions.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Reactor for converting a medium, comprising: alternately successively arranged layers of a catalyst carrier and of an insulating material, the reactor being electrically heated, the layers of the catalyst carrier and of the insulating material are arranged perpendicular to the main flow direction of the medium, the medium flows essentially perpendicularly through the layers of the catalyst carrier and of the insulating material, and the catalyst is a component of an electric circuit.

2. Reactor according to claim 1,
wherein a first electric contact is arranged at a first contact point of the catalyst carrier and a second electric contact is arranged at a second contact point of the catalyst carrier such that the electric current flow takes place essentially perpendicular to the flow direction of the medium through the catalyst carrier.

3. Reactor according to claim 1,
wherein several layers of the catalyst carrier are arranged in the flow direction of the medium, one or several layers of the electric insulating material being arranged between two or several layers of the catalyst carrier at least in areas.

4. Reactor according to claim 1,
wherein the catalyst carrier is constructed as strips, the catalyst carrier being covered at least in areas by one or several strips of electric insulating material.

5. Reactor according to claim 3,
wherein the catalyst carrier is wound in the manner of a filter candle around a first pipe piece, and the first pipe piece and the catalyst carrier are enclosed at least in areas by a second pipe piece closed on one side, the first and the second pipe piece each forming a component of a medium line.

6. Reactor according to claim 5,
wherein the first pipe piece is electrically connected with the first electric contact, and an electric passage for the electric contacting of the second electric contact of the catalyst carrier is provided in the second pipe piece.

7. Reactor according to claim 5,
wherein areas with a different cross-section and/or a different electric resistance are arranged along the longitudinal dimension of the catalyst carrier.

8. Reactor according to claim 2,
wherein the electric insulating material has catalyst material at least in areas.

9. Reactor according to claim 1,
wherein the catalyst carrier is formed of a metallic woven fabric and/or of a metallic network and/or of a perforated plate and/or of a sponge-type metallic material.

10. A reactor for converting a medium, the reactor comprising:
alternately arranged layers of a catalyst carrier and an electric insulating material;
a main flow path of the medium, wherein the alternately arranged layers of the catalyst carrier and the electric insulating material are positioned essentially perpendicular to the main flow path of the medium, allowing the medium to flow essentially perpendicularly through the layers of the catalyst carrier and the electric insulating material; and
an electric circuit, the catalyst carrier being a part of the electric circuit, wherein the electric circuit is used to heat the reactor.

11. The reactor according to claim 10,
wherein an electric current flow through the electric circuit is essentially perpendicular to the main flow path of the medium through the catalyst carrier.

12. The reactor according to claim 10,
wherein each of the catalyst carrier and electric insulating material is configured as a strip, an area of the catalyst carrier being covered by a strip of the electric insulating material.

13. The reactor according to claim 12,
wherein the catalyst carrier is wound in the manner of a filter candle around a first pipe piece, and the first pipe piece and the catalyst carrier are enclosed by a second pipe piece having a closed end, the first and second pipe pieces each forming a component of a medium line.

14. The reactor according to claim 13,
wherein the catalyst carrier has sections with different electric resistance along the direction of the electric current flow in the catalyst carrier.

15. The reactor according to claim 13,
wherein the sections has cross-section areas of different sizes to vary electric resistance.

16. The reactor according to claim 11,
wherein an area of the electric insulating material has catalyst material.

17. The reactor according to claim 10,
wherein the catalyst carrier is formed of a metallic woven fabric.

18. The reactor according to claim 10,
wherein the catalyst carrier is formed of a metallic network.

19. The reactor according to claim 10,
wherein the catalyst carrier is formed of a perforated plate.

20. The reactor according to claim 10,
wherein the catalyst carrier is formed of a sponge-type metallic material.

21. A method of making a reactor for converting a medium, the method comprising:
defining a main flow path of the medium;
alternately arranging layers of a catalyst carrier and an electric insulating material and positioning the alternately arranged layers of the catalyst carrier and the electric insulating material essentially perpendicular to the main flow path of the medium, allowing the medium to flow essentially perpendicularly through the layers of the catalyst carrier and the electric insulating material; and
providing an electric circuit and making the catalyst carrier a part of the electric circuit, wherein the electric circuit is used to heat the reactor.

22. The method according to claim 21, further comprising:
arranging an electric current flow through the electric circuit essentially perpendicular to the main flow path of the medium through the catalyst carrier.

23. The method according to claim 21, further comprising:
dividing the catalyst carrier into sections with different electric resistance along the direction of the electric current flow in the catalyst carrier.

24. The method according to claim 23,
wherein the sections has cross-section areas of different sizes to vary electric resistance.

25. The method according to claim 24, further comprising:
placing a catalyst material on an area of the electric insulating material.

26. A reactor for converting a medium, the reactor comprising:
a catalyst carrier means;
means for insulating the catalyst carrier means;
a main flow path of the medium, wherein the means for insulating the catalyst carrier means and the catalyst carrier means are positioned essentially perpendicular to the main flow path of the medium, allowing the medium to flow essentially perpendicularly through the means for insulating the catalyst carrier means and the catalyst carrier means; and
an electric heating means, the catalyst carrier means being a part of the electric heating means, wherein the electric heating means is used to heat the reactor.
